(19) United States
(12) Patent Application Publication
(10) Pub. No.: US 2017/0066955 A1
(43) Pub. Date: Mar. 9, 2017

(54) THERMAL INTERFACE MATERIAL

(71) Applicant: Polytronics Technology Corp., Hsinchu (TW)

(72) Inventors: Kuo Hsun CHEN, Toufen City (TW); Yi An SHA, Xindian City (TW)

(21) Appl. No.: 15/156,781

(22) Filed: May 17, 2016

(30) Foreign Application Priority Data
Sep. 7, 2015 (TW) 104129573

(51) Int. Cl. C09K 5/14

(52) U.S. Cl. CPC C09K 5/14

(57) ABSTRACT

A thermal interface material comprises a fluoroelastomer component and a heat conductive filler evenly dispersed in the fluoroelastomer component. The fluoroelastomer component contains greater than 50% fluorine and has a Mooney viscosity ML₍₁₊₁₀₎ less than 60 at 121° C. The heat conductive filler comprises 40-65% by volume of the thermal interface material. The thermal interface material is manufactured by solventless processes, and has a heat conductivity between 0.7 W/m·K-9 W/m·K.

### BACKGROUND OF THE INVENTION

(1) Field of the Invention

The present application relates to a thermal interface material, and more specifically, to a thermal interface material with high heat conductivity and high heat resistance.

(2) Description of the Related Art

Electronic devices and light emitting diode (LED) devices, or other semiconductor devices typically generate a significant amount of heat during operation. If the heat cannot dissipate effectively, these devices would decrease the functionality, cause malfunction or burnout. The devices are usually mounted onto a heat sink with a thermal interface material disposed therebetween, so as to combine the devices with the heat sink and provide intimate contact therebetween to facilitate heat transfer.

Traditionally, a thermal interface material may use organic silicone polymer system or epoxy resin system. The organic silicone polymer system comprises silicone grease and silicone rubber. After being used over time, they may have migration of grease to unwanted areas and hardened material problems. Although the epoxy resin system has advantages of high adherence and low cost, it has worse temperature resistance and would suffer material deterioration after being used at a high temperature for a long time.

U.S. Pat. No. 6,776,226 discloses a thermal interface material containing a fluoroelastomer in place of the traditional material to overcome the drawbacks. The thermal interface material comprises a blend of fluoroelastomer components, e.g., copolymers of hexafluoropropylene and vinylidene fluoride. The fluoroelastomer blend contains at least one component with a Mooney viscosity of 50 poise or less and at least one component with a Mooney viscosity of greater than 50 poise. The low viscosity component of the blend provides the property of good surface wetting under heat and/or pressure to the material. The high Mooney viscosity component of the blend provides the thermal interface material with good handling and compression set properties. The combination of fluoroelastomer components of high viscosity and low viscosity will produce a material having sufficient integrity to be solid at room temperature and properties of a low viscosity material. Thus, the resulting material will provide good surface wetting to metals and plastics. However, the thermal interface material needs two fluoroelastomer components of different viscosities, and the ratio of high to low viscosity fluoroelastomer components will affect thermal resistance. Therefore, the processes are more complicated and the material stability would be influenced.

In the process of manufacturing thermal interface material, is fluoroelastomer components are typically dissolved in a solvent before kneading or adding thermal conductive filler. The processes are complicated, and the solvent is not friendly to environment protection.

### SUMMARY OF THE INVENTION

To resolve the aforementioned problem of the thermal interface material, the present application devised a thermal interface material using a specific fluoroelastomer component. The thermal interface material has high heat conductivity providing superior heat dissipation, good heat resistance and chemistry resistance, and is able to perform resilience and compression like rubbers.

In accordance with an embodiment of the present application, a thermal interface material comprises a fluoroelastomer component and a heat conductive filler evenly dispersed in the fluoroelastomer component. The fluoroelastomer component contains greater than 50% fluorine and has a Mooney viscosity ML₍₁₊₁₀₎ less than 60 at 121° C., which is measured according to ASTM D1646. The heat conductive filler comprises 40-65% by volume of the thermal interface material. The fluoroelastomer component is suitable for being proceeded without solvent, and thus the thermal interface material can be made by solventless processes. The thermal interface material has a heat conductivity between 0.7 W/m·K and 9 W/m·K.

In an embodiment, the fluoroelastomer component is selected from polymers, copolymers or mixtures containing the following structural formula:

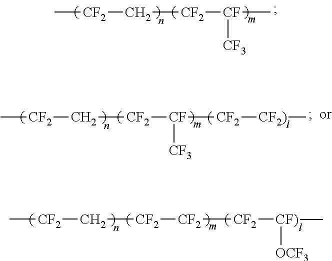

wherein “l”, “m” and “n” are positive integers.

In an embodiment, the heat conductive filler may comprise aluminum oxide, aluminum nitride, boron nitride, silicon carbide or mixtures thereof. The heat conductive filler comprises 40-65%, e.g., 45%, 50%, 55%, or 60%, by volume of thermal interface material.

In an embodiment, the thermal interface material exhibits good chemistry resistance and heat resistance in a case of containing a single kind of fluoroelastomer. In other words, the thermal interface material has only one fluoroelastomer component, and does not include other kinds of fluoroelastomer components.

In an embodiment, the thermal interface material further comprises a coupling agent having single or plural fluorine functional groups.

In an embodiment, the fluoroelastomer component comprises 30-60%, e.g., 35%, 40%, 45%, 50% or 55%, by volume of the thermal interface material.

In an embodiment, the heat conductive filler may comprise aluminum oxide, aluminum nitride, boron nitride, silicon carbide, magnesium oxide, zinc oxide or mixtures thereof, and may have a particle size of 3-70 μm.

In an embodiment, the thermal interface material may comprise a crosslink agent, e.g., bisphenol, peroxide or amine, for crosslinking. Alternatively, the crosslink may be performed by radiation.

Because the thermal interface material behaves as rubbers in some aspects, polymer manufacturing processes, such as extrusion, calendering or injection molding, can be employed to form sheets of the thermal interface material.

The thermal interface material contains a specific fluoroelastomer component to enhance heat resistance and chemistry resistance effectively and can be proceeded by extrusion, calendering or injection molding to is form sheets. The specific fluoroelastomer component is adapted to solventless processes which are simple and do not incur environmental contamination.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

In accordance with an embodiment of the present application, a thermal interface material comprises a fluoroelastomer component and a heat conductive filler dispersed in the fluoroelastomer component. The fluoroelastomer component comprises 30-60% by volume of the thermal interface material, and the heat conductive filler comprises 40-65% by volume of the thermal interface material. The thermal interface material has a heat conductivity between 0.7 W/m·K and 9 W/m·K, e.g., 1 W/m·K, 2 W/m·K, 4 W/m·K, 6 W/m·K, or 8 W/m·K.

In an embodiment, the fluoroelastomer component has more than 50% or 60% fluorine, and may have the following structural formula:

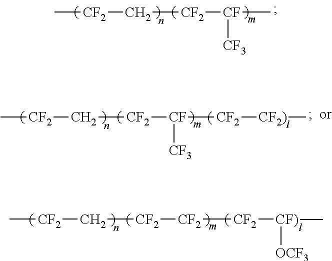

wherein “l”, “m” and “n” are positive integers. The heat conductive filler may only contain a single kind of fluoroelastomer to simplify processes and enhance material stability. Besides, the copolymers or mixtures of the fluoroelastomer component may be used.

The fluoroelastomer component may use Daikin Industries, Ltd. DAI-EL™ G751, G752, G755, G763, G781, G783, G558, G575, G902; 3M™ Dyneon™ FC2211, FC2210, FC2145, FE5522, FE5832, FT2350. The fluoroelastomer component has a Mooney viscosity ML₍₁₊₁₀₎ less than 60 (MU) or 40 (MU) at 121° C., in which the Mooney viscosity is measured according to ASTM D1646.

In an embodiment, the heat conductive filler may comprise aluminum oxide, aluminum nitride, boron nitride, silicon carbide, magnesium oxide, zinc oxide or mixtures thereof. The heat conductive filler has a particle size of about 3-70 μm, or 10-50 μm in particular.

The following Tables 1 and 2 show the composition of the thermal interface materials of the present application. In the embodiments (denoted by Em), the fluoroelastomer component uses DAI-EL™ G755 containing 66% fluorine and having a Mooney viscosity ML₍₁₊₁₀₎ of 25, or contains 3M™ Dyneon™ FT2350 having 68.6% fluorine and a Mooney viscosity ML₍₁₊₁₀₎ of 56. The heat conductive filler may use but not limited to aluminum oxide, aluminum nitride and/or boron nitride. In the comparative examples (denoted by Comp), traditional silicone polymer rather than fluoroelastomer is used. The coupling agents of the embodiments use Dow Corning Q3-9030 containing a single or plural fluorine functional groups. The fluorine functional groups may have structural formula as the follows, for coupling fluoroelastomer and heat conductive ceramic powder (heat conductive filler).

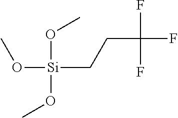

TABLE 1

| | Fluoro- | Fluoro- | | Coupling | |
|---|---|---|---|---|---|
| | elastomer | elastomer | Aluminum | agent | |
| | G755 | FT2350 | oxide | Q3-9030 | Heat conductivity |
| Em | (vol %) | (vol %) | (vol %) | (vol %) | (W/m · K) |
| 1 | 54% | — | 46% | — | 0.93 |
| 2 | — | 54% | 46% | — | 0.87 |
| 3 | 50% | — | 50% | — | 2.09 |
| 4 | — | 50% | 50% | — | 1.99 |
| 5 | 30% | 20% | 50% | — | 2.06 |
| 6 | 49.5% | — | 50% | 0.5% | 2.33 |
| 7 | — | 49.5% | 50% | 0.5% | 2.17 |
| 8 | 30% | 19.5% | 50% | 0.5% | 2.29 |

TABLE 2

| | Fluoro- | | Coupling | | | | |
|---|---|---|---|---|---|---|---|
| | elastomer | Silicone | agent | Aluminum | Aluminum | Boron | Heat |
| | G755 | polymer | Q3-9030 | oxide | nitride | nitride | conductivity |
| Em | (vol %) | (vol %) | (vol %) | (vol %) | (vol %) | (vol %) | (W/m · K) |
| 9 | 44.5% | — | 0.5% | 55% | — | — | 3.31 |
| 10 | 44.5% | — | 0.5% | — | 55% | — | 4.15 |
| 11 | 44.5% | — | 0.5% | — | — | 55% | 3.83 |
| 12 | 37.0% | — | — | 63% | — | — | 5.67 |
| 13 | 36.5% | — | 0.5% | 63% | — | — | 6.33 |
| 14 | 39.5% | — | 0.5% | 50% | 10% | — | 5.85 |
| 15 | 34.5% | — | 0.5% | 60% | — | 5% | 7.33 |
| 16 | 34.5% | — | 0.5% | 58% | — | 7% | 8.10 |
| 17 | 39.5% | — | 0.5% | 60% | — | — | 5.15 |
| Comp | — | 40% | — | 60% | — | — | 4.65 |

As shown in Tables 1 and 2, the fluoroelastomer component comprises G755 or FT2350, and heat conductive filler comprises aluminum oxide, aluminum nitride, boron nitride or mixtures thereof. The thermal interface material is adapted to be made by solventless processes and exhibits a heat conductivity of 0.7 W/m·K-9 W/m·K, e.g., 1 W/m·K, 2 W/m·K, 4 W/m·K, 6 W/m·K, or 8 W/m·K. The more heat conductive filler, the higher heat conductivity is. Aluminum nitride and boron nitride usually have higher heat conductivity than aluminum oxide. The fluoroelastomer component contains 30-60% by volume of the thermal interface material. The heat conductive filler comprises 40-65% by volume of the thermal interface material. The coupling agent comprises 0.5-1% by volume of the thermal interface material.

Table 3 shows the variations of heat conductivities of “Em 17” and “Comp” over time. In the Em 17, an initial heat conductivity is 5.15 W/m·K. The material heats up at ambient temperature of 230° C. for 200, 400, 600, 800 and 1000 hours, and then cools down to room temperature of 25° C. The corresponding heat conductivities are 5.21 W/m·K, 5.17 W/m·K, 5.07 W/m·K, 5.08 W/m·K and 5.11 W/m·K, respectively. It appears that the thermal interface material of the present application retains heat conductivity without deterioration after being put in a high-temperature environment over time. To the contrary, the comparative example containing silicone polymer has an initial heat conductivity of 4.65 W/m·K. The material heats up at ambient temperature of 230° C. for 200, 400, 600, 800 and 1000 hours, and then cools down to room temperature 25° C. The heat conductivities are 4.53 W/m·K, 4.15 W/m·K, 3.87 W/m·K 2.81 W/m·K and 1.85 W/m·K, respectively. It can be seen that, as to the comparative example, the longer the high-temperature treatment, the lower the heat conductivity is. In other words, the material containing silicone polymer suffers high-temperature deterioration.

TABLE 3

| | Heat conductivity (W/m · K) | | | | | |
|---|---|---|---|---|---|---|
| | | 230° C./ | 230° C./ | 230° C./ | 230° C./ | 230° C./ |
| | Initial | 200 hrs | 400 hrs | 600 hrs | 800 hrs | 1000 hrs |
| Em 17 | 5.15 | 5.21 | 5.17 | 5.07 | 5.08 | 5.11 |
| Comp | 4.65 | 4.53 | 4.15 | 3.87 | 2.81 | 1.85 |

In manufacturing, the fluoroelastomer component and the heat conductive filler are blended in a kneader to form a kneaded paste, and then it is subjected to extrusion, calendering or injection molding to generate sheets of a desired thickness. Solvent is not needed for entire processes. Because the use of solventless extrusion, calendering or injection molding, some materials of high viscosity cannot be used for the present application. In contrast, high viscosity material may be employed for solvent processes that may utilize daubing or screen printing. Compared to traditional solvent is processes, solvent-removing step is omitted for the present application. Therefore, there are no solvent residues and voids that may be resulted from quick solvent removal.

The thermal interface material may add a crosslink agent, e.g., bisphenol, peroxide, or diamine, to crosslink the material by high-temperature treatment, or may be crosslinked by radiation, thereby obtaining high mechanical strength, dimensional stability and environmental endurance. The crosslink temperature is about 150-210° C., and crosslink time is equal to or less than 60 minutes.

In the present application, the specific fluoroelastomer component can enhance heat resistance and chemistry resistance of the thermal interface material, and the processes such as extrusion, calendering and injection molding can be used to form sheets of the material. In particular, the specific fluoroelastomer component is adapted to be proceeded with solventless processes. Accordingly, the manufacturing process can be simplified and avoid environmental contamination.

The above-described embodiments of the present invention are intended to be illustrative only. Numerous alternative embodiments may be devised by persons skilled in the art without departing from the scope of the following claims.

What is claimed is:

1. A thermal interface material, comprising:
a fluoroelastomer component comprising more than 50% fluorine and a Mooney viscosity ML₍₁₊₁₀₎ less than 60 at 121° C.; and
a heat conductive filler evenly dispersed in the fluoroelastomer component, the heat conductive filler comprising 40-65% by volume of the thermal interface material;
wherein the thermal interface material has a heat conductivity between 0.7 W/m·K-9 W/m·K and is manufactured by solventless processes.

2. The thermal interface material of claim 1, wherein the fluoroelastomer component comprises polymer, copolymer or mixtures thereof having the following structural formula: 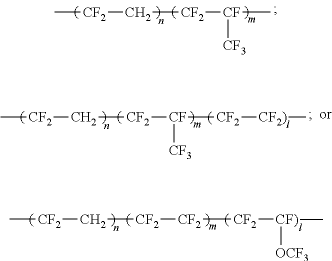
wherein “l”, “m” and “n” are positive integers.

3. The thermal interface material of claim 1, wherein the fluoroelastomer component is crosslinked by a crosslink agent selected from the group consisting of bisphenol, peroxide or amine.

4. The thermal interface material of claim 1, wherein the thermal interface material comprises a single kind of fluoroelastomer.

5. The thermal interface material of claim 1, further comprising a coupling agent with single or plural fluorine functional groups.

6. The thermal interface material of claim 1, wherein the fluoroelastomer component comprises 30-60% by volume of the thermal interface material.

7. The thermal interface material of claim 1, wherein the heat conductive filler is selected from the group consisting of aluminum oxide, aluminum nitride, boron nitride, silicon carbide, magnesium oxide, zinc oxide or mixtures thereof.

8. The thermal interface material of claim 1, wherein the heat conductive filler has a particle size of 3-70 μm.

9. The thermal interface material of claim 1, wherein the fluoroelastomer component is crosslinked by radiation.

10. The thermal interface material of claim 1, wherein the thermal interface material is formed by extrusion, calendering or injection molding.
